(19) United States
(12) Patent Application Publication
(10) Pub. No.: US 2004/0096592 A1
(43) Pub. Date: May 20, 2004

(54) Electroless cobalt plating solution and plating techniques

(76) Inventors: Ramanan V. Chebiam, Hillsboro, OR (US); Valery M. Dubin, Portland, OR (US); Harsono S. Simka, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/300,276

(22) Filed: Nov. 19, 2002

(51) Int. Cl. C23C 18/34; C23C 18/36; B05D 1/18

(52) U.S. Cl. 427/443.1; 106/1.22; 106/1.27

(57) ABSTRACT

An electroless cobalt plating solution, comprising cobalt ions, at least one reducing agent, and an ammonia-free complexing/buffering agent (such as glycine, triethanolamine, and tris(hydrozymethyl)aminoethane). The electroless cobalt plating solution may be used in the fabrication of variety of structures including copper diffusion barriers and salicides contact in the manufacture of microelectronic dice.

### BACKGROUND OF THE INVENTION

1. Field of the Invention

The present invention relates generally to the manufacture of microelectronic devices. In particular, the present invention relates to the using electroless cobalt plating technique for the formation of elements within a microelectronic die, wherein the cobalt plating solution including an ammonia-free complexing/buffering agent.

2. State of the Art

The plating of metals is a well-known process used to change the surface properties or dimensions of a plating target. Generally, the target is plated to improve the physical properties of the target, such as improving the electrical characteristics of the target and/or rendering target more resistant to abrasion and/or corrosion.

Various methods of metal plating are known in the art. However, the most common techniques are electroplating and electroless plating. Electroplating involves the formation of an electrolytic cell wherein an anode is typically constructed from the metal to be plated and the target is a cathode. The anode and the target (cathode) are placed in an appropriate solution and an electrical charge is introduced to the electroplating cell to disassociate metal atoms from the plating metal which then migrate through the solution to coat the target (cathode).

Electroless plating involves the deposition of a metal coating from a solution onto the target (substrate) by a controlled chemical reduction reaction. The metal or metal alloy being deposited generally catalyzes the controlled chemical reduction reaction. Electroless plating has several advantages over electroplating. For example, electroless plating requires no electrical charge applied to the target, electroless plating generally results in a more uniform and nonporous metal layer on the target even when the target has an irregular shape, and electroless plating is autocatalytic and continuous once the process is initiated.

An electroless plating solution generally includes water, a water soluble compound containing the metal (in ion form) to be deposited onto the target (substrate), a complexing agent that prevents chemical reduction of the metal ions in solution while permitting selective chemical reduction on a surface of the target, and a chemical reducing agent for the metal ions. Additionally, the plating solution may also include a buffer for controlling pH and various optional additives, such as solution stabilizers and surfactants. It is, of course, understood that the composition of a plating solution will vary depending on the desired outcome.

In the electronics industry, there is an on-going demand for higher performance and increased miniaturization of integrated circuit components within the microelectronic dice. As these goals are achieved, the geometry of microelectronic die integrated circuitry becomes smaller or is “scaled down”. As the geometry is scaled down, the properties of the conductive traces and interconnects within build-up layers begin to dominate the overall speed of the integrated circuitry. The build-up layer of the microelectronic die generally comprises a plurality of interlayer dielectric layers having conductive traces and passive components formed therebetween, and interconnects formed through the interlayer dielectric layers to connection such conductive traces, passive components, and the circuitry of the microelectronic die.

In order to increase the speed and reliability of the conductive traces and interconnects, the electronics industry has moved away from using aluminum to using copper or copper alloys as a preferred material for the conductive traces. Copper has a lower resistivity (resulting in lower resistance-capacitance interconnect delay) and better electromigration characteristics than aluminum.

One problem that can occur in the use of copper-containing materials is copper's tendency to diffuse through interlayer dielectric materials, which can result in shorts circuits with neighboring traces and interconnects. Thus, copper-containing structures are generally substantially surrounded by diffusion barriers to prevent such diffusion.

One diffusion barrier material that can be used is cobalt. Cobalt layer are usually formed in an electroless plating technique, as discussed above. A typical electroless cobalt plating solutions can comprise Co ions (i.e., Co²⁺ which may be provided by cobalt chloride (CoCl₂), cobalt sulfate (CoSO₄), and the like), citric acid as complexing agent, NH₄Cl (ammonium chloride) or (NH₄)₂SO₄ (ammonium sulfate) as a buffer agent, DMAB(dimethylamineborane) and/or H₂PO₂ (phosphoric acid) as reducing agents, and TMAH (tetramethylammonium hydroxide) as a pH adjuster.

However, the ammonia-based buffering agents results in the evaporation of ammonia, through the following reaction: NH₄(aq)+OH⁻(aq)⇄NH₃ (gas)+H₂O. This evaporation results in strong odors and result in unstable pH during plating, as the pH can decrease due to the NH₃ evaporation. Furthermore, such plating solutions may have a limited effective pH range (between about 8.3 and 9.2).

Therefore, it would be advantageous to develop an electroless plating solution, which reduces or substantially eliminates pH instability and ammonia evaporation.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1-9 are cross-sectional views illustrating a method of forming a copper-containing structure within a build-up layer, according to the present invention;

FIGS. 10-12 are cross-sectional views of forming a silicide contact, according to the present invention;

FIG. 13 is a cross-sectional view of cobalt barrier layers on bond pads of a microelectronic die and a microelectronic substrate, according to the present invention;

FIG. 14 is a schematic of an electrolytic cell, according to the present invention; and

FIG. 15 is a flow diagram of a method of mixing the ammonia-free cobalt plating solution, according to the present invention.

### DETAILED DESCRIPTION OF THE ILLUSTRATED EMBODIMENT

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention includes an electroless cobalt plating solution and a method of plating items with cobalt. The electroless cobalt plating solution, comprising cobalt ions, at least one reducing agent, and an ammonia-free complexing/buffering agent (such as glycine, triethanolamine, and tris(hydrozymethyl)aminoethane).

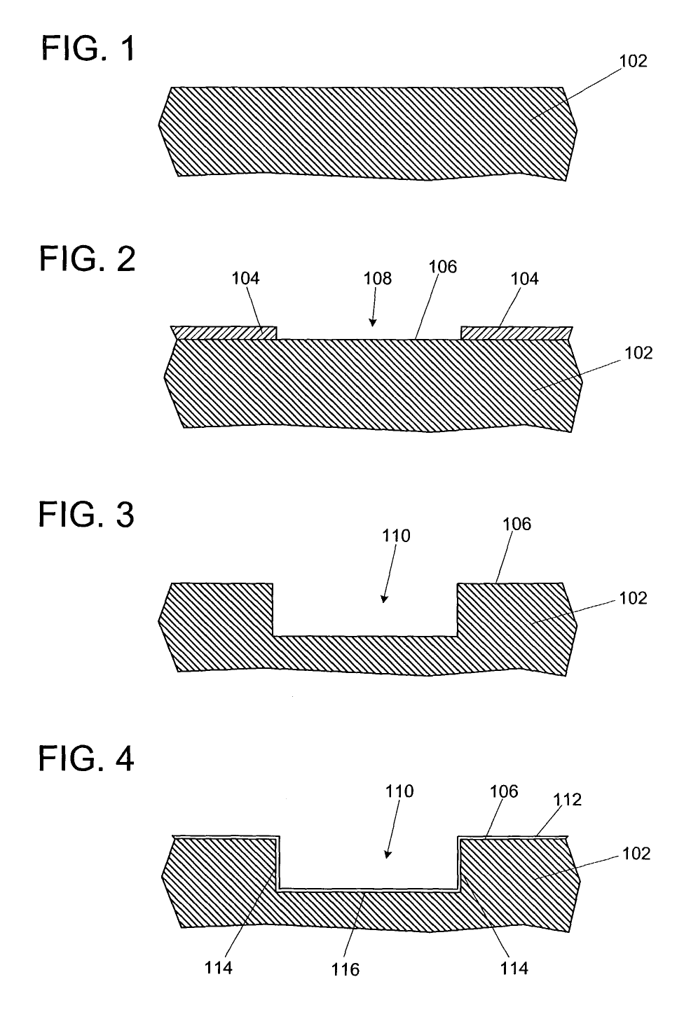

FIGS. 1-9 illustrate a method of fabricating a copper-containing structure. FIG. 1 illustrates a first interlayer dielectric (hereinafter “ILD”) layer 102, including but not limited to silicon dioxide, silicon nitride, silicon oxynitride, and the like. It is, of course, understood that the first ILD layer 102 can occur anywhere within a build-up layer of a microelectronic device.

As shown in FIG. 2, a resist material 104 is pattern on a first surface 106 of the first ILD layer 102 to have an opening 108 therethrough. The first ILD layer 102 is then etched to form a recess 110 (such as a line trench or via) which extends from the first ILD first surface 106 into the first ILD layer 102, by any technique known in the art, and any excess resist material 104 is removed, as shown in FIG. 3.

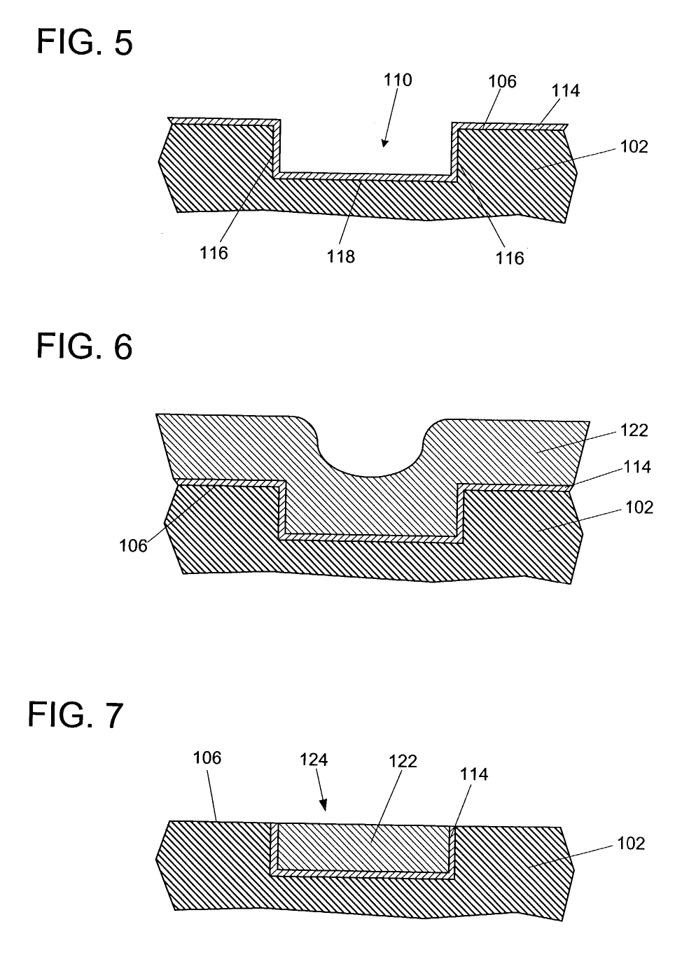

As shown in FIG, 4, a seed layer 112, such as palladium, a palladium/cobalt alloy, and the like, may be formed on the first ILD layer first surface 106 and inside walls 116 and bottom 118 of the recess 110. As shown in FIG. 5, a cobalt diffusion barrier layer 114 is plated on the seed layer 112 in an ammonia-free electroless cobalt plating solution of the present invention.

In one example, the ammonia-free electroless cobalt plating solution may include:

Cobalt ions (i.e., i.e., Co²⁺ which may be provided by cobalt chloride (CoCl₂), cobalt sulfate (CoSO₄), and the like), preferably ranging from about 2 to 40 grams-per-liter (gpl)

A reducing agent(s), preferably DMAB (dimethylamineborane) ranging from about 1 to 20 gpl and AHP (ammonium hypophosphite) ranging from about 0 to 30 gpl

An ammonia-free complexing/buffer agent, ranging from about 10 to 100 gpl

A pH adjuster, preferably tetramethylammonium hydroxide (TMAH) in an amount to achieve a desired pH value

A solvent, preferably water or ethylene glycol

The ammonia-free electroless cobalt plating solution is preferably at a pH between about 7.5 and 10.5, and at a temperature between about 35° C. to 60° C.

The ammonia-free complexing/buffer agent is preferably selected from glycine (most preferred), triethanolamine, and tris(hydrozymethyl)aminoethane (TRIZMA). These agents have been found to act as both a buffer and a complexing agent, which eliminates the need to add an additional complexing agent (such as citric acid discussed above).

| Complexing/Buffer Agent | Formula | MW | Pka | pH range |
|---|---|---|---|---|
| Triethanolamine (TEA) | C₆H₁₅NO₃ | 149.2 | 7.8 | 6.9-8.5 |
| Tris(hydrozymethyl)aminoethane | C₄H₁₁NO₃ | 121.1 | 8.1 | 7.0-9.1 |
| (TRIZMA) | | | | |
| Glycine | C₂H₅NO₂ | 75 | 97 | 8.2-10.1 |

The ammonia-free electroless cobalt plating solution may have several advantages over the standard NH₄Cl/TMAH and (NH₄)₂SO₄/TMAH buffer systems (discussed above) including, but not limited to, being active over a broad and stable pH range, having better pH control (i.e., no pH decrease due to ammonia evaporation), easy to replenish the solution, easy to control component concentrations, allows lower deposition temperature, allows a broader pH range for deposition, creates less odor during plating (i.e., less or no ammonia outgassing), soluble in aqueous solutions, stable in the presence of reducing agents, allows lower cobalt and DMAB concentrations, allows deposition in less alkaline conditions (i.e., does not introduce alkali metal ions), and low or no precipitation of the Co²⁺ ions.

As shown in FIG. 6, a layer of copper-containing material 122 is then deposited over the diffusion barrier layer 114. The copper-containing material layer 122 may be deposited by any technique know in the art, including but not limited to plating, chemical vapor deposition, physical deposition, and the like. The copper-containing material 122 may be substantially pure copper or any alloy thereof.

As shown in FIG. 7, a portion of the copper-containing material layer 122 and a portion of the diffusion barrier layer 114 is removed, preferably by a chemical-mechanical polishing (CMP) technique, to leave substantially only the portion of the copper-containing material layer 122 and only the portion of the diffusion barrier layer 114 which reside in the opening 108 (see FIG. 3). Thus, a conductive trace 124 is thereby formed which is electrically isolated.

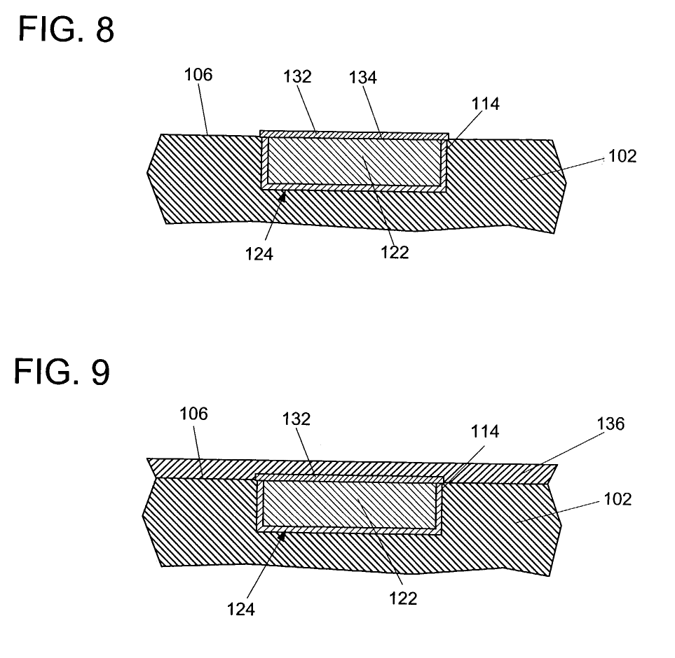

The ammonia-free cobalt plating solution may also be used to form a shunt layer on the conductive trace 124. As shown in FIG. 8, the shunt layer 132 may be form on a first layer 134 of the conductive trace 124, by any known technique as will be understood by those skilled in the art. The shunt layer to improves electromigration reliability and provides a current path if a void is formed in the conductive trace 124, as will also be understood by those skilled in the art. The illustrated portion of the build-up layer is completed by disposing a second ILD layer 136 over the first ILD layer 102 and the conductive trace 124, as shown in FIG. 9.

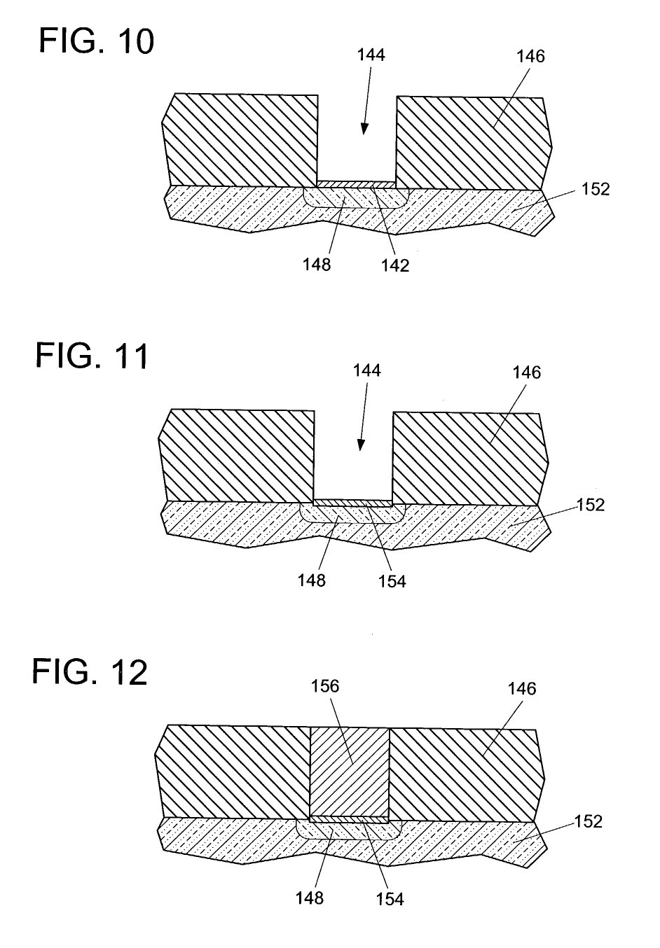

It is, of course, understood that the present invention is not limited to the formation of conductive traces/interconnect or to microelectronic die build-up layers. The present invention can be used in the formation of various elements in the microelectronic die and can be translated in the fabrication of various electronic devices, as well as other industries. For example, the electroless plating solution may be used in the formation of silicide cotacts. Salicide contacts are used to reduce contact resistance with the point of electrical contact between metal interconnects and source/drain regions implanted in a silicon substrate. As shown in FIG. 10, a layer of cobalt 142 may be plated in a via 144 within a dielectric layer 146, which extends to a source/drain implantation region 148 within a silicon substrate 152. The cobalt layer 142 is heated with reacts the cobalt with the silicon substrate 152 to form a conductive cobalt silicide layer 154, as shown in FIG. 11. As shown in FIG. 12, a metal interconnect 156 is then formed in the via 144 (shown in FIG. 10).

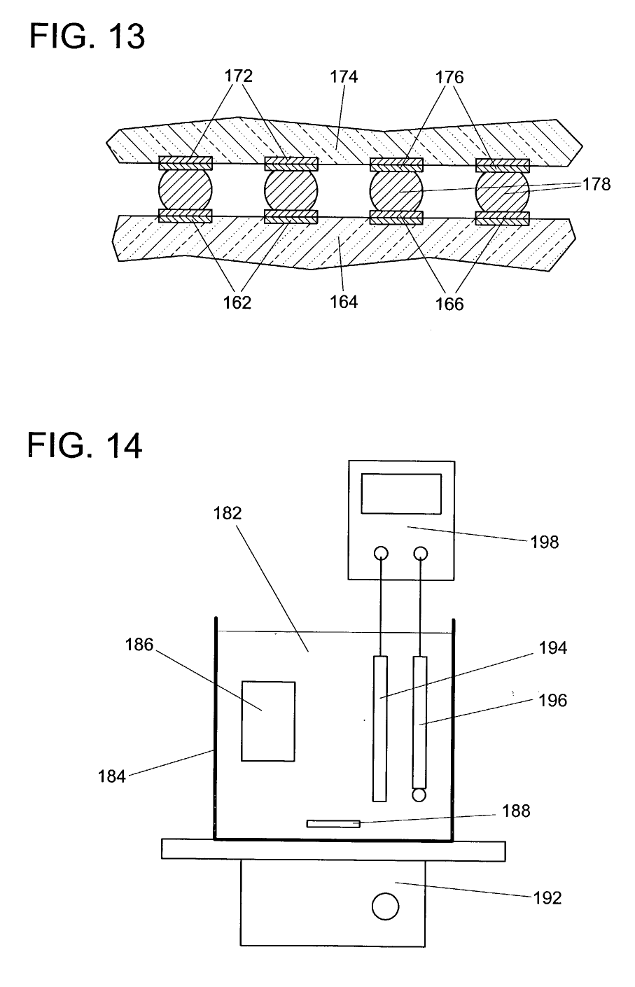

The present invention may, of course, be used in any situation for the prevention of the migration of copper. For example, copper bond pads 162 on a carrier substrate 164 may be coated with a cobalt layer 166 and/or copper bond pads 172 on a microelectronic device 174 may be coated with a cobalt layer 176 to prevent the copper within the copper-containing bond pads 162 and/or the copper-containing bond pads 172 from migrating into the interconnect 178, such as a tin solder ball, as shown in FIG. 13.

FIG. 14 illustrates a is a schematic of a electrolytic cell, according to the present invention. The schematic illustrates an ammonia-free cobalt plating solution 182 disposed in a container 184, wherein a plating target 186 is immersed. The ammonia-free cobalt plating solution is stirred with a magnetic stir bar 188 controlled by a magnetic stirring device 192. The temperature of the solution is monitored by a temperature probe 194 and the pH of the solution is monitored by pH probe 196. Both the temperature probe 194 and the pH probe 196 are connected to a control/display device 198.

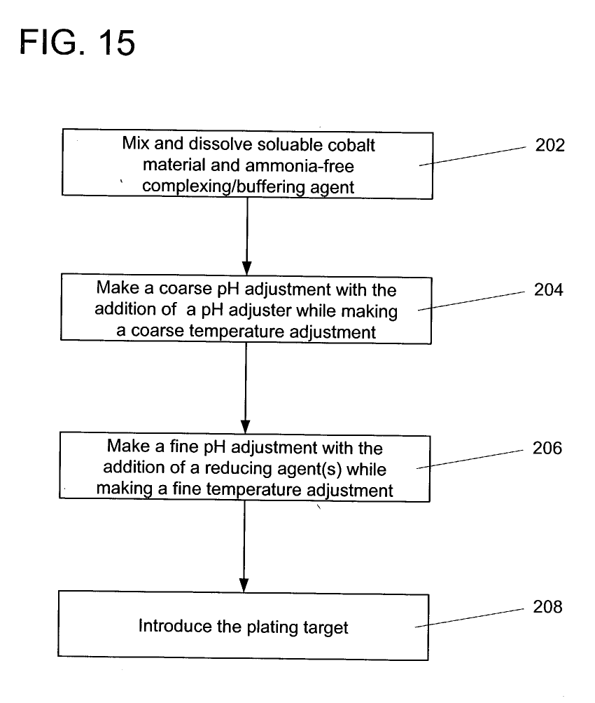

FIG. 15 illustrates a method of mixing the ammonia-free cobalt plating solution. In step 202, a soluble cobalt material (such as cobalt chloride) is mixed with an ammonia-free complexing/buffer agent (such as glycine) and dissolved in water. In step 204, a coarse pH adjustment is made with the addition of a pH adjuster (such as TMAH) while making coarse temperature adjustments. In step 206, fine pH adjustment is made with the addition of a reducing agent(s) (such as DMAB and AHP) while making a fine temperature adjustment to form the ammonia-free cobalt plating solution. In step 208, the plating target is then introduced to the ammonia-free cobalt plating solution.

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. An electroless cobalt plating solution, comprising:
cobalt ions;
at least one reducing agent; and
an ammonia-free complexing/buffering agent.

2. The electroless cobalt plating solution of claim 1, wherein said ammonia-free complexing/buffering agent is selected from the group consisting glycine, triethanolamine, and tris(hydrozymethyl)aminoethane.

3. The electroless cobalt plating solution of claim 1, wherein said ammonia-free complexing/buffering agent is in a concentration ranging from about 10 to 100 grams-per-liter of solution.

4. The electroless cobalt plating solution of claim 1, wherein said cobalt ions are in a concentration ranging from about 2 to 40 grams-per-liter of solution.

5. The electroless cobalt plating solution of claim 1, wherein said at least one reducing agent comprises dimethylamineborane.

6. The electroless cobalt plating solution of claim 5, wherein said dimethylamineborane is in a concentration ranging from about 1 to 20 grams-per-liter of solution.

7. The electroless cobalt plating solution of claim 1, wherein said at least one reducing agent comprises ammonium hypophosphite.

8. The electroless cobalt plating solution of claim 7, wherein said ammonium hypophosphite is in a concentration up to about 30 grams-per-liter of solution.

9. The electroless cobalt plating solution of claim 1, further including a pH adjuster.

10. The electroless cobalt plating solution of claim 9, wherein said pH adjuster comprises tetramethylammonium hydroxide.

11. A method of forming a cobalt layer comprising:
providing an electroless cobalt plating solution comprising cobalt ions, at least one reducing agent; and an ammonia-free complexing/buffering agent; and
immersing a plating target into said electroless cobalt plating solution.

12. The method of claim 11, wherein providing said electroless cobalt plating solution comprises providing an electroless cobalt plating solution comprising said ammonia-free complexing/buffering agent selected from the group consisting glycine, triethanolamine, and tris(hydrozymethyl)aminoethane.

13. The method of claim 11, wherein providing said electroless cobalt plating solution comprises providing an electroless cobalt plating solution comprising said ammonia-free complexing/buffering agent in a concentration ranging from about 10 to 100 grams-per-liter of solution.

14. The method of claim 11, wherein providing said electroless cobalt plating solution comprises providing an electroless cobalt plating solution comprising said cobalt ions in a concentration ranging from about 2 to 40 grams-per-liter of solution.

15. The method of claim 11, wherein providing said electroless cobalt plating solution comprises providing an electroless cobalt plating solution having said at least one reducing agent comprising dimethylamineborane.

16. The method of claim 15, wherein providing said electroless cobalt plating solution comprises providing an electroless cobalt plating solution having said dimethylamineborane in a concentration ranging from about 1 to 20 grams-per-liter of solution.

17. The method of claim 11, wherein providing said electroless cobalt plating solution comprises providing an electroless cobalt plating solution having said at least one reducing agent comprising ammonium hypophosphite.

18. The method of claim 17, wherein providing said electroless cobalt plating solution comprises providing an electroless cobalt plating solution having said ammonium hypophosphite in a concentration up to about 30 grams-per-liter of solution.

19. The method of claim 11, wherein providing said electroless cobalt plating solution comprises providing an electroless cobalt plating solution further including a pH adjuster.

20. The method of claim 19, wherein providing said electroless cobalt plating solution comprises providing an electroless cobalt plating solution including said pH adjuster comprising tetramethylammonium hydroxide.

21. A method of forming a copper diffusion barrier comprising:
providing an electroless cobalt plating solution comprising cobalt ions, at least one reducing agent; and an ammonia-free complexing/buffering agent;
providing a plating target having at least one copper-containing structure thereon; and
plating a cobalt layer on said at least one copper-containing structure by immersing said plating target into said electroless cobalt plating solution.

22. The method of claim 21, wherein providing said electroless cobalt plating solution comprises providing an electroless cobalt plating solution comprising said ammonia-free complexing/buffering agent selected from the group consisting glycine, triethanolamine, and tris(hydrozymethyl)aminoethane.

23. The method of claim 21, wherein providing said electroless cobalt plating solution comprises providing an electroless cobalt plating solution comprising said ammonia-free complexing/buffering agent in a concentration ranging from about 10 to 100 grams-per-liter of solution.

24. The method of claim 21, wherein providing said electroless cobalt plating solution comprises providing an electroless cobalt plating solution comprising said cobalt ions in a concentration ranging from about 2 to 40 grams-per-liter of solution.

25. The method of claim 21, wherein providing said electroless cobalt plating solution comprises providing an electroless cobalt plating solution having said at least one reducing agent comprising dimethylamineborane.

26. The method of claim 25, wherein providing said electroless cobalt plating solution comprises providing an electroless cobalt plating solution having said dimethylamineborane in a concentration ranging from about 1 to 20 grams-per-liter of solution.

27. The method of claim 21, wherein providing said electroless cobalt plating solution comprises providing an electroless cobalt plating solution having said at least one reducing agent comprising ammonium hypophosphite.

28. The method of claim 27, wherein providing said electroless cobalt plating solution comprises providing an electroless cobalt plating solution having said ammonium hypophosphite in a concentration up to about 30 grams-per-liter of solution.

29. The method of claim 21, wherein providing said electroless cobalt plating solution comprises providing an electroless cobalt plating solution further including a pH adjuster.

30. The method of claim 29, wherein providing said electroless cobalt plating solution comprises providing an electroless cobalt plating solution including said pH adjuster comprising tetramethylammonium hydroxide.
